(19) United States
(12) Patent Application Publication
(10) Pub. No.: US 2023/0173963 A1
(43) Pub. Date: Jun. 8, 2023

(54) VEHICLE SUBASSEMBLY HAVING A PLANAR COMPONENT AND PRODUCTION METHOD

(71) Applicant: Brose Fahrzeugteile SE & Co. Kommanditgesellschaft, Coburg, Coburg (DE)

(72) Inventors: Arnold ERBEN, Berlin (DE); Johannes MERK, Hohen-Neuendorf (DE); Denis SCHMIDT, Berlin (DE); Matthias BAUMECKER, Berlin-Spandau (DE)

(73) Assignee: Brose Fahrzeugteile SE & Co. Kommanditgesellschaft, Coburg, Coburg (DE)

(21) Appl. No.: 17/357,671

(22) PCT Filed: Dec. 20, 2019
(86) PCT No.: PCT/EP2019/086517

§ 371 Date: Jun. 24, 2021

(30) Foreign Application Priority Data
Dec. 24, 2018 (DE) 10 2018 133 584.9

(51) Int. Cl. B60N 2/58

(52) U.S. Cl. CPC B60N 2/5891

(57) ABSTRACT

A vehicle subassembly includes at least one planar component. The at least one component has a material-specific deformability. To at least locally increase the deformability, through-holes are provided on at least one section of the at least one component. A method of producing of the component is also disclosed.

### CROSS-REFERENCE TO RELATED APPLICATIONS

This application is the U.S. National Phase of PCT Application No. PCT/EP2019/086517 filed Dec. 20, 2019, which claims priority to German Patent Application No. DE 10 2018 133 584.9 filed Dec. 24, 2018, the disclosures of which are hereby incorporated in their entirety by reference herein.

### TECHNICAL FIELD

The proposed solution relates to a vehicle subassembly having at least one planar component and to a method of producing a planar component of a vehicle.

### BACKGROUND

Such a vehicle subassembly may be suitable for arrangement inside and outside a vehicle. The at least one component has a material-specific deformability.

### SUMMARY

According to a first aspect of this disclosure, a proposed vehicle subassembly is provided with through-holes on at least one section of the at least one component in order to at least locally increase the deformability.

A through-hole may be a cutout, a hole or a slot, for example, and in one embodiment may be produced by removing material from the component. At least one through-hole hence may also be formed to be pocket-shaped by removing material. In principle, pockets may be arranged on the at least one section in order to at least locally increase the deformability.

By removing material or incorporating slots, through-holes of any shape may be produced. The through-holes may be slot-shaped, for example. A slot may be several times as long as it is wide. The through-holes may constitute narrow, long depressions or openings in the component. The through-holes also may have any geometric shape. For example, the through-holes may be of circular, rectangular or elliptical shape. The slot-shaped through-holes may be formed to have a linear open shape. The open shapes may be modeled on open letters. Examples of open letters include the letters W, E, T, Z, S, F, G, J, K, L, V, N, M, C, U, X or Y and combinations thereof.

The material-specific deformability may be an inherent property of a component. The deformability may be dependent for example on a hardness, a rigidity and/or on bending properties of a material from which the component is made. In principle, the deformability may depend for example on a thickness of a layered component. By providing through-holes, the deformability may at least locally be increased.

In one exemplary embodiment, a section with through-holes is adjacent to a section without through-holes. The deformability of the section with through-holes may be greater than the deformability of the section without through-holes.

The through-holes may be produced, for example, by removing material. For this purpose, computer-controlled production methods may be used. The through-holes may be arranged in such a way that the deformability of the component may locally be adapted to load paths along which the component is loaded.

The through-holes may be designed to allow rotating, pivoting and/or parallel displacement of parts of the component relative to each other. For this purpose, the shape of the through-holes, the arrangement of the through-holes relative to each other and the size of the section provided with through-holes on the component may be varied.

In one exemplary embodiment, through-holes are arranged periodically offset from each other on the at least one section. For example, a first through-hole may be arranged offset from an adjacent second through-hole, and a third through-hole, which is the next but one neighbor of the first through-hole, may be arranged at the same level as the first through-hole. A fourth through-hole, which is the next but one neighbor of the second through-hole, may be arranged at the same level as the second through-hole. Hence, the four through-holes may be arranged periodically offset from each other. In principle, any length of periodicity of displacement of the through-holes is conceivable and possible.

In another exemplary embodiment, the through-holes form a regular pattern on the at least one section. For example, the arrangement of the through-holes may produce an interesting optical effect. A structure of the arrangement of the through-holes hence may remain the same over the at least one section. The through-holes hence may both be repetitive in shape and may be arranged at a repetitive fixed distance and angle to each other.

The through-holes may be incorporated into the at least one section in the manner of a cutting pattern. For producing the planar component, a cutting pattern template, for example, may be used, which includes a two-dimensional image of the planar component, on which through-holes are indicated. As a result, the component may be made from a flat, planar piece of material that is flexibilized in at least one section by incorporating the through-holes, so that it may be brought into a three-dimensional shape.

An alternative embodiment of the component is a hinge. The through-holes for a hinge-like component may be formed, for example, by linear cuts offset from each other in parallel and may have oblong shape. Another embodiment of the component may be a comfort surface in a vehicle seat or any other seat component. The through-holes then may be formed, for example, by regular patterns. As a result, the comfort surfaces may give way when they are utilized by a vehicle occupant. For example, the through-holes of the comfort surfaces may have various sizes to vary the deformability within the comfort surface. Furthermore, an application of the component for a trim part, for example, an interior door trim or a dashboard lining, is conceivable and possible. On the at least one section with through-holes, the trim part may include a movable bulge or a formation with differences in height and/or depth. In an alternative embodiment, the component may form a storage compartment.

In one exemplary embodiment, at least one bulge is formed on the at least one section with through-holes. The at least one bulge may be formed by a guide body on the at least one section with through-holes. The guide body may lift the component on the at least one section with through-holes from a carrier on which the component is held. The guide body may be shiftable for positioning the at least one bulge along the at least one section with through-holes. For example, the guide body may be guided on the carrier. The at least one bulge then may be positionable on the carrier. For example, the guide body may include a display panel of a dashboard of a vehicle, which may be positioned along an axis transversely to the vehicle longitudinal direction via the guide body.

In one exemplary embodiment, the at least one section with through-holes may form a force-transmitting element that is material-elastically movable. The force-transmitting element, for example, may be a hinge or a joint connection. Such a force-transmitting element may be arranged in a vehicle seat as a joint connection. For example, the force-transmitting element may be usable to realize a longitudinal and height adjustment of the vehicle seat, a depth and inclination adjustment of a seat underpart, an inclination and side bolster adjustment of the backrest, a height and inclination adjustment of a headrest, and the like. For this purpose, a first and a second surface part may be integrally arranged on the force-transmitting element. The first and the second surface part may be less deformable than the at least one section with through-holes.

In one embodiment, the force-transmitting element may transmit actuating forces and/or load forces, which result from the utilization of the component, from the first surface part to the second surface part.

In another exemplary embodiment, the at least one section with through-holes forms a curve element which may be arranged, for example, on an arm support of an interior door trim. The first and the second surface part of the component may be integrally arranged on the curve element obliquely to each other. The curve element may produce an elastic connection between the first surface part and the second surface part. In an alternative embodiment, the first surface part may be pivotable relative to the second surface part so that an angle between the two surface parts is adjustable via the curve element.

Also disclosed is a method of producing a component which has a material-specific deformability. According to a second aspect of the proposed solution, through-holes are incorporated into at least one section of the component to at least locally increase the deformability. As a result, more freedom of movement may be provided to the component at selected points.

In one exemplary embodiment, the through-holes are incorporated into the at least one section in the manner of a cutting pattern. The size and kind of the chosen cutting pattern may influence the degrees of freedom provided to the component at the at least one section by incorporating the through-holes. Degrees of freedom for example include a rotation, pivoting or displacement at the at least one section with through-holes. For example, sections without through-holes, such as the first and second surface parts, may be integrally arranged on the at least one section, which may be rotated, pivoted and/or shifted relative to each other via the at least one section with through-holes.

In one exemplary embodiment, the planar component is used for a seat component, a trim part, a hinge and/or a storage compartment of the vehicle subassembly.

The method is suitable for producing a component of the first aspect of the proposed solution, but is not limited thereto.

### BRIEF DESCRIPTION OF THE DRAWINGS

In the attached Figures, exemplary embodiments of the proposed solution are shown by way of example.

FIG. 1A shows a schematic view of a first and a second component;

FIG. 1B shows a perspective view of a first and a second component for a vehicle seat;

FIG. 2A shows a component for a dashboard;

FIG. 2B shows an alternative component for a dashboard; and

FIG. 3 shows a vehicle subassembly with a seat vehicle seat and a dashboard.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

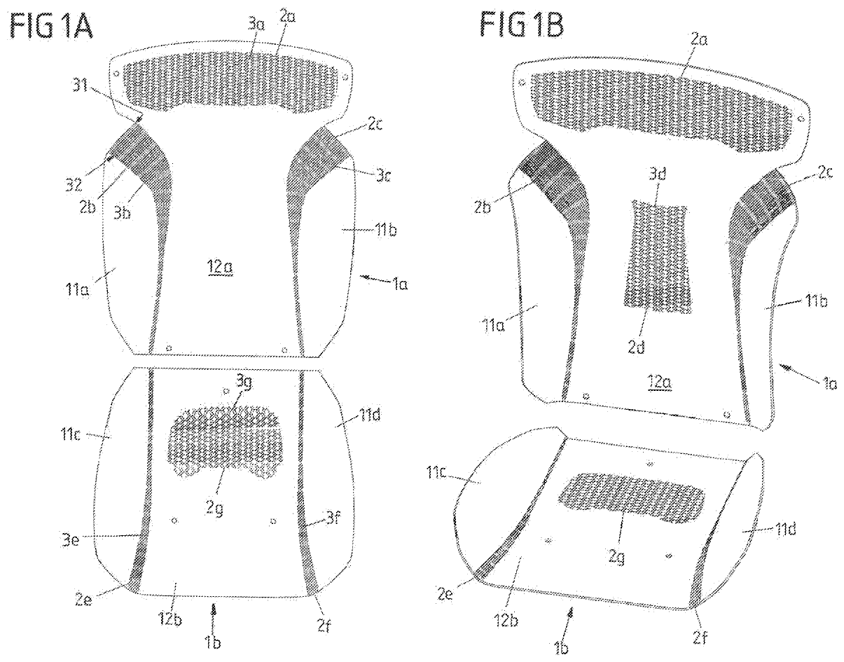

FIG. 1A shows an exemplary embodiment including two flat components 1a, 1b for a vehicle seat. The first component 1a is configured as a backrest that is suitable for a vehicle occupant sitting on the vehicle seat to lean against. The second component 1b is formed as a seating surface that is suitable for a vehicle occupant to sit on.

The components 1a, 1b are formed as thin layers that are shaped into a backrest or a seating surface. Depending on the weight of the vehicle occupant and the material-specific deformability of the components 1a, 1b, the components 1a, 1b may deform when the vehicle occupant sits on or leans against them. For example, a component 1a, 1b including a layer of plastic material may have a higher deformability than a component 1a, 1b which includes a layer of metal. The deformability hence is material-specific. In principle, the deformability may be definable by a chemical composition of the component 1a, 1b.

On the components 1a, 1b, through-holes are provided on each of three or four sections 2a, 2b, 2c, 2e, 2f, 2g. In principle, any number of sections may be provided on the components 1a, 1b, on which sections through-holes are arranged. The through-holes locally increase the deformability of the components 1a, 1b at the sections 2a, 2b, 2c, 2e, 2f, 2g. On each of the sections 2a, 2b, 2c, 2e, 2f, 2g more than fifty through-holes are provided. In principle, at least two through-holes may be provided on a section 2a, 2b, 2c, 2e, 2f, 2g in order to locally increase the deformability at the section 2a, 2b, 2c, 2e, 2f, 2g. A through-hole is formed by a slot-shaped opening in the components 1a, 1b.

A first section 2a is provided in a region of the first component 1a, against which a shoulder girdle of a vehicle occupant properly seated on the vehicle seat rests. The first section 2a therefore may give way due to the increased deformability, when the vehicle occupant leans against the first section 2a.

Second and third sections 2b, 2c laterally flank a back of a vehicle occupant properly sitting on the vehicle seat and, based on the back, are arranged on the first component 1a symmetrically with respect to each other. By the second and third sections 2b, 2c, the first component 1a is integrally divided into two first surface parts 11a, 11b and one second surface part 12a. The two first surface parts 11a, 11b protrude from the plane of the second surface part 12a in the direction of the vehicle occupant. The vehicle occupant is partly enclosed by the two first surface parts 11a, 11b proceeding from his back. The second and third sections 2b, 2c each form a curve element so that the two first surface parts 11a, 11b are obliquely arranged on the second surface part 12a. The two first surface parts 11a, 11b are arranged at an angle unequal to 180° or 360° relative to the second surface part 12a. In principle, the two first surface parts 11a, 11b may be angularly arranged at any angle with respect to the second surface part 12a. Additionally or alternatively, the two first surface parts 11a, 11b may be formed as a force-transmitting element, as it is described below.

The two first surface parts 11a, 11b each are pivotally articulated to the second surface part 12a via the second and third sections 2b, 2c. By shifting his weight, for example, the vehicle occupant may pivot the two first surface parts 11a, 11b relative to the second surface part 12 to an extent specified by the local deformability at the second or third section 2b, 2c. Hence, the two first surface parts 11a, 11b give way relative to the second surface part 12a, when the vehicle occupant leans against the same. In a region close to the shoulder girdle of the vehicle occupant, a width of the second and third sections 2b, 2c is greater than in a region close to the lower back of the vehicle occupant.

Fourth and fifth sections 2e, 2f laterally flank a vehicle occupant properly sitting on the second component 1b and are arranged symmetrically with respect to each other, based on the vehicle occupant. In a region close to the knee of the vehicle occupant, a surface area of the fourth and fifth sections 2e, 2f is greater than in a region close to the lower back of the vehicle occupant. By the fourth and fifth sections 2e, 2f, the second component 1b is integrally divided into two third surface parts 11c, 11d and a fourth surface part 12b. The two third surface parts 11c, 11d protrude from the plane of the fourth surface part 12b in the direction of the vehicle occupant. The vehicle occupant is partly enclosed by the two third surface parts 11c, 11d proceeding from his thighs.

The two third surface parts 11c, 11d each are pivotally articulated to the fourth surface part 12b via the fourth and fifth sections 2e, 2f. By shifting his weight, for example, the vehicle occupant may pivot the two third surface parts 11c, 11d relative to the fourth surface part 12b to an extent specified by the local deformability at the fourth or fifth section 2e, 2f. Hence, the two third surface parts 11c, 11d give way relative to the fourth surface part 12b, when the vehicle occupant leans against the same. As a result, the two third surface parts 11c, 11d transmit load forces resulting from the utilization of the second component 1b to the fourth surface part 12b. The fourth and the fifth section 2e, 2f therefore may be formed as a force-transmitting element. In principle, the fourth and the fifth section 2e, 2f may be formed as a curve element.

A sixth section 2g is arranged in a region of the second component 1b from which the back of the vehicle occupant protrudes. The sixth section 2g hence may give way when the vehicle occupant sits down on the vehicle seat.

The through-holes 3a, 3g of the first and sixth sections 2a, 2g form the shape of a dumbbell. For this purpose, two Y-shaped cutouts are combined with each other. A plurality of through-holes 3a, 3g are arranged along a common axis. The longitudinal axes of the dumbbell-shaped through-holes 3a, 3g therefore are arranged on a straight line. Several of this plurality of through-holes 3a, 3g each are arranged equidistantly, in parallel, and offset from each other along the longitudinal axis by half a length of a through-hole 3a, 3g. The through-holes 3a, 3g hence are arranged periodically offset from each other. The through-holes 3a, 3g of the first and sixth sections 2a, 2g thereby form a regular pattern that is honeycomb-shaped. The geometrical dimensions of the through-holes 3g vary within the sixth section 2g.

The dumbbell-shaped through-holes 3a, 3g may be provided on a section 2a, 2g of a component 1a, 1b, that is intended to be more deformable, in response to a force exerted on the section 2a, 2g, than is allowed by the material-specific deformability of the component 1a, 1b. Such compressive forces may be produced, for example, when a vehicle occupant leans against the section 2a, 2g or when a vehicle occupant sits down on the section 2a, 2g. The arrangement of the through-holes 3a, 3g relative to each other may be equidistant, parallel to and/or offset from each other, or as desired.

The through-holes 3b, 3c, 3e, 3f of the second, third, fourth and fifth sections 2b, 2c, 2e, 2f are of slot-shaped design. The through-holes 3b, 3c, 3e, 3f are extended along lines that may have straight sections and arcuate sections. A plurality of through-holes 31, for example, on the second section 2b is extended parallel to each other. A further plurality 32 of through-holes 42, which likewise are extended parallel to each other, here are arranged such that the plurality of through-holes 31 engage into the further plurality of through-holes 32 in a comb-like manner, i.e., interleaved. The through-holes 3b of the plurality and the further plurality of through-holes 31, 32 hence are arranged periodically offset from each other. The through-holes 3b, 3c, 3e, 3f of the second, third, fourth and fifth sections 2b, 2c, 2e, 2f thereby form a regular pattern in so far as a number of through-holes 3b, 3c, 3e, 3f per surface periodically varies along a direction of extension of the through-holes 3b, 3c, 3e, 3f. The second, third, fourth and fifth sections 2b, 2c, 2e, 2f have an alternately higher and lower number of through-holes 3b, 3c, 3e, 3f per surface. The number of through-holes 3b, 3c, 3e, 3f per surface varies also along a longitudinal axis of the through-holes 3b, 3c, 3e, 3f.

FIG. 1B shows a perspective view of first and second components 1a, 1b similar to the preceding exemplary embodiment, wherein the first component 1a includes a seventh section 2d. The seventh section 2d is of trapezoidal shape and arranged centrally on the first component 1a so that a center of the back of the vehicle occupant rests against the seventh section 2d. The seventh section 2d includes a plurality of dumbbell-shaped through-holes 3d in order to allow the seventh section 2d to give way perpendicularly to the plane of the first component 1a, when the vehicle occupant leans against the first component 1a formed as a backrest.

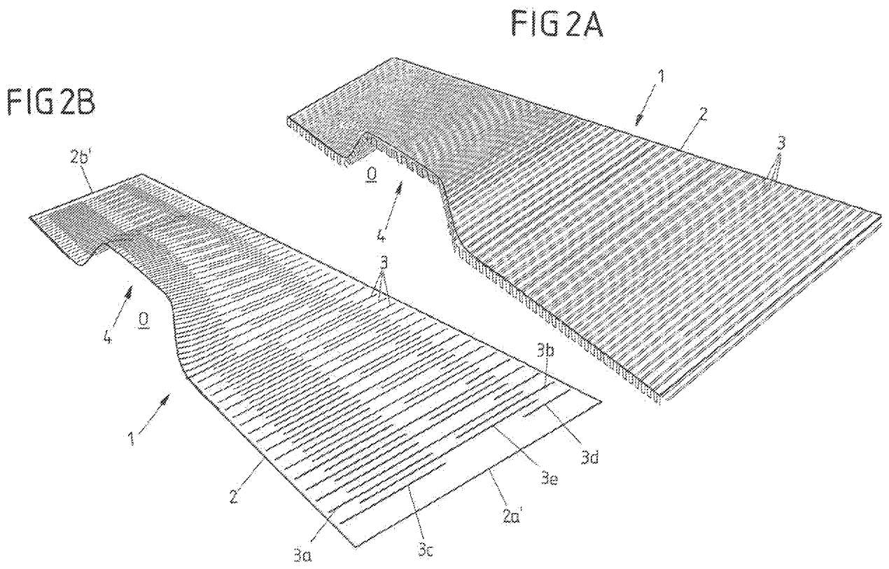

Another exemplary embodiment of a planar component 1 is shown in FIG. 2A. The component 1 is formed as a trim part. It includes a plurality of parallel through-holes. The entire component 1—not only a section—includes through-holes 3. The component 1 forms un undulating structure. The undulating structure may have periodicity. For example, the through-holes 3 may be arranged parallel to each other with the same periodicity. For example, a row of through-holes 3 may be arranged in a wave trough, and an adjacent row of through-holes 3 may be arranged on a wave peak.

Two through-holes 3 each form a pair whose distance to each other is fixed. Different adjacent pairs have different distances to each other.

At one end of the component 1, the distance between adjacent pairs is greater than the distance of the through-holes 3 of a pair to each other. Proceeding from the end, pairs of through-holes 3 adjacent along a direction transverse to the longitudinal axes of the through-holes 3 sectionally are disposed closer to each other than pairs disposed at a greater distance from each other. The distance between the pairs may be zero. Adjacent pairs may also intersect. When the distance between adjacent pairs is zero, the distance between adjacent pairs increases along the direction transverse to the longitudinal axes of the through-holes 3 proceeding from the point at which the distance is zero.

On the component 1, a bulge 4 may be formed. The bulge 4 is of wedge-shaped design. As a result, the component 1 is bulged more at a part of the bulge 4 along a direction of extension of the through-holes 3 than at another part of the bulge 4. Across the bulge 4, a cavity-shaped opening O is formed on the planar component 1.

In an alternative exemplary embodiment with a curvature 4 as shown in FIG. 2B, the through-holes 3 are arranged on a section 2 of the component 1 formed as a trim part. Two further sections 2a′, 2b′, on which no through-holes are provided, may be utilized for example for fastening the component 1 within the vehicle subassembly.

The through-holes 3 are arranged parallel to each other. Transversely to a direction of extension of the through-holes 3, two short through-holes 3a, 3b each are arranged on a common straight line and are separated from another pair of two short through-holes 3c, 3d by a single long through-hole 3e. The length of the short through-holes 3a, 3b or of a short through-hole 3a, 3b may vary periodically. In principle, the length of the through-holes 3 and the arrangement relative to each other may be varied as desired. The through-holes 3 may be incorporated into the section 2 in the manner of a cutting pattern.

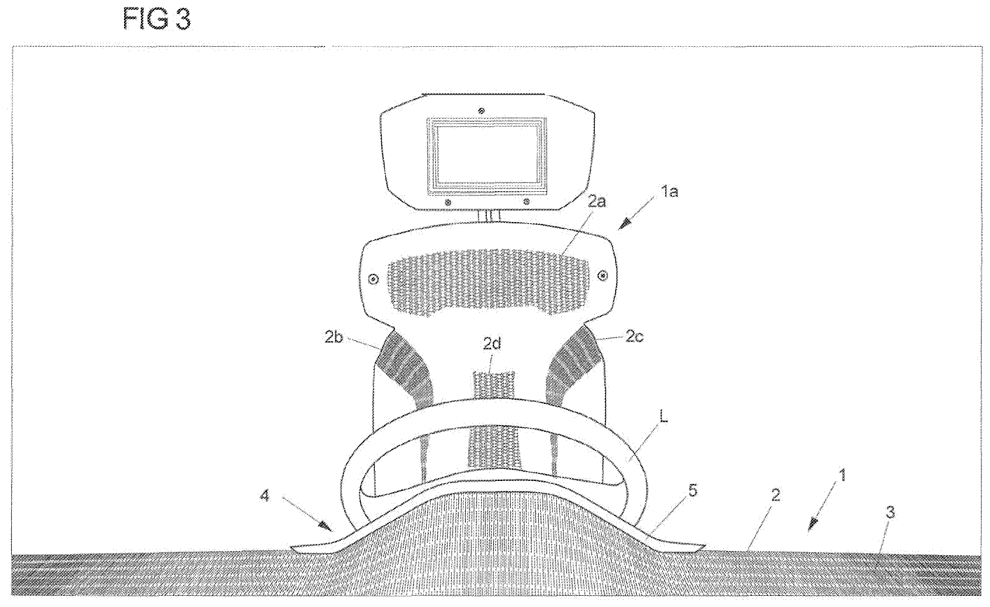

FIG. 3 shows another exemplary embodiment with a bulge 4, in which four or five differently long through-holes 3 each are arranged on a common straight line and are offset from three or four differently long, adjacent parallel through-holes 3 by half the length of one of the longest through-holes 3. Via a guide body 5, the bulge 4 is formed on the portion 2 with the through-holes. The guide body 5 is shiftable along the section 2 for positioning the bulge 4. Due to the through-holes 3, the component 1 is deformable on the section 2 so that the bulge 4 may be positioned on the section 2 by means of the guide body 5 as desired.

The bulge 4 is arranged on a display panel (not shown) behind a steering wheel L of the vehicle, so that the display panel is received within the bulge 4 and a vehicle occupant may look through the steering wheel L onto the display panel from the vehicle seat. The display panel is shiftable along the section 2 together with the bulge 4. The vehicle seat includes a first component 1a with first, second, third and seventh sections 2a, 2b, 2c, 2d according to the exemplary embodiment of FIG. 1B.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

### LIST OF REFERENCE NUMERALS

1, 1a, 1b component
11a, 11b, 11c, 11d, 12a, 12b surface part
2, 2a, 2b, 2c, 2d, 2e, 2f, 2g section
2a′, 2b′ further section
3, 3a, 3b, 3c, 3d, 3e, 3f through-holes
31, 32 plurality of through-holes
4 bulge
5 guide body
L steering wheel
O opening

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A vehicle subassembly comprising:
at least one planar component having a material-specific deformability, wherein the at least on planer component defines a plurality of through-holes that at least locally increase the material-specific deformability of at least one section of the at least one component.

2. The vehicle subassembly according to claim 1, wherein the through-holes are slot-shaped, circular, dumbbell-shaped and/or Y-shaped.

3. The vehicle subassembly according to claim 1, wherein, on the at least one section, the through-holes are arranged periodically offset from each other.

4. The vehicle subassembly according to claim 3, wherein, on the at least one section, the through-holes form a regular pattern.

5. The vehicle subassembly according to claim 1, wherein the through-holes are incorporated into the at least one section in a cutting pattern.

6. The vehicle subassembly according to claim 1, wherein the least one planar component at least partially forms a seat component, a trim part, a hinge and/or a storage compartment of the vehicle subassembly.

7. The vehicle subassembly according to claim 1, wherein the at least one section with the through-holes has at least on bulge.

8. The vehicle subassembly according to claim 7, further comprising a guide body that receives an edge portion of the planar component such that the guide body deforms the planar component to form the at least one bulge wherein the guide body is shiftable along the at least one section to shift a location of the bulge.

9. The vehicle subassembly according to claim 1, wherein the at least one section with the through-holes forms a force-transmitting element on which a first and a second surface part of the component are integrally arranged, and which transmits forces resulting from utilization of the component from the first surface part to the second surface part.

10. The vehicle subassembly according to claim 1, wherein the at least one section with the through-holes forms a curve element on which a first and a second surface part of the component are integrally arranged obliquely to each other, wherein the curved element produces an elastic connection between the first surface part and the second surface part.

11. A method of producing a planar component of a vehicle subassembly that has a material-specific deformability comprising:
forming through-holes though at least one section of the planar component to at least locally increase the deformability of the at least one section.

12. The method according to claim 11, wherein the through-holes are incorporated into the at least one section in a cutting pattern.

13. The method according to claim 11, wherein the planar component is one or more of a seat component, a trim part, a hinge, and a storage compartment of the vehicle subassembly.

14. The method according to claim 11 further comprising forming a bulge in the at least one section.

15. The method according to claim 11 further comprising inserting the planar component into a guide body to form a bulge in the at least one section.

16. The method according to claim 11, wherein the through-holes are slots.

17. The method according to claim 11, wherein the through-holes are arranged periodically offset from each other.

18. The method according to claim 11, wherein the through-holes form a regular pattern.

19. The method according to claim 11, wherein the at least one section with the through-holes forms a force-transmitting element on which a first and a second surface part of the component are integrally arranged, and which transmits at least one of actuating forces and load forces resulting from utilization of the component from the first surface part to the second surface part.

20. The method according to claim 11, wherein the at least one section with the through-holes forms a curve element on which a first and a second surface part of the component are integrally arranged obliquely to each other, wherein the curved element produces an elastic connection between the first surface part and the second surface part.
